(19) United States
(12) Patent Application Publication
(10) Pub. No.: US 2016/0131754 A1
(43) Pub. Date: May 12, 2016

(54) DEVICE FOR DETECTING ELECTROMAGNETIC SIGNALS

(71) Applicant: THALES, Courbevoie (FR)

(72) Inventors: Pascal CORNIC, GUILERS (FR); Patrick LE BIHAN, LANNILIS (FR); Régis LEVAUFRE, CAVAN (FR)

(21) Appl. No.: 14/904,405

(22) PCT Filed: Jul. 15, 2014
(86) PCT No.: PCT/EP2014/065154

§ 371 Date: Jan. 11, 2016

(30) Foreign Application Priority Data
Jul. 19, 2013 (FR) 1301719

(51) Int. Cl. G01S 13/44; G01S 3/74

(52) U.S. Cl. CPC G01S 13/4454; G01S 3/74

(57) ABSTRACT

A device for detecting electromagnetic signals comprising an array receive antenna having N radiating elements and M receive channels downstream of the receive antenna, M less than N, the pointing directions of the antenna, equal to the radiating elements, obtained by adaptive beamforming and regularly spaced apart, comprises: switching the M receive channels onto the radiating elements in successive sequence cycles, M radiating elements connected to the receive channels with each sequence, the same radiating element, being the reference element, connected to the receive channels for all sequences, one cycle completed when all radiating elements are connected to one of the receive channels; for each sequence, estimating two-by-two spatial correlations of the signal received on the reference channel and the signals received on the other M-1 receive channels, then estimating the spatial power spectral density in N incoming directions based on a coherent sum of N correlation terms obtained.

The present invention relates to a device for detecting electromagnetic signals. The field of the invention is that of the separation and localization of electromagnetic sources using array antennas. The field of operation potentially covers the entire field of electromagnetic signal receivers. More particularly, the invention relates to the field of active or passive electromagnetic interceptors in which an instantaneous wide-angle coverage and a substantial angular separation capacity are required, in particular in order to segregate the low-power and long-pulse received signals in a dense environment.

In this context, a technical problem to be solved lies in minimizing the number of receive channels in an array antenna device, the aim being to reduce simultaneously the complexity, the volume of computation to be carried out and ultimately the cost.

The problem is normally solved by means of adaptive beamforming techniques or by means of interferometry techniques.

A substantial angular separation power requires a narrow antenna beam and therefore a large antenna. Thus, the greater the angular separation power required by an application, the greater the dimension L of the antenna must be. In fact, the antenna aperture, denoted Δθ, once focused, is, for a wavelength λ, typically in the form Δθ=λ/L in radians, i.e. inversely proportional to the dimension L.

The large dimension of the antenna then entails the use of a large number of radiating elements making up this antenna. These radiating elements must be spaced apart from one another by a wavelength fraction, typically λ/2 for a total angular coverage of 90°. This condition is in fact necessary in order to avoid angular direction ambiguities. Thus, for an antenna having an aperture 1/N, the number of radiating elements will generally be typically 2N for a linear antenna and 4N² for a surface antenna. Each radiating element has a corresponding receiver, resulting in a great complexity and a high cost.

A solution exists which reduces the number of receivers using “lacunar” antennas or ambiguous interferometry arrays.

As far as lacunar antennas are concerned, the degradations in the radiation pattern increase as a function of the lacunarity rate, which in practice does not enable a significant reduction in the number of receivers.

As far as interferometric antennas are concerned, they provide high localization precision with a small number of radiating elements, the value of the precision being inversely proportional to the dimension of the antenna. However, they require the elimination of the angular direction measurement ambiguities using at least two interferometry bases having different dimensions. This ambiguity elimination method may be unsuccessful if the density of signals to be processed is high or if the signal-to-noise ratio is low. In the presence of long-duration signals, for example LPI (“Low Probability of Intercept”) signals, the risk of temporal signal overlap increases, which further complicates the analysis of the received signals.

It may then become impossible to separate the signals by their direction or to estimate this incoming direction.

One object of the invention is to overcome the aforementioned disadvantages, for which purpose the subject-matter of the invention is a device for detecting electromagnetic signals comprising an array receive antenna having N radiating elements and comprising M receive channels downstream of the receive antenna, M being less than N, the pointing directions of said antenna, equal in number to the number N of radiating elements, being obtained by means of adaptive beamforming and being regularly spaced apart, said device furthermore comprising at least:

means for switching the M receive channels onto the radiating elements according to successive sequence cycles, M radiating elements being connected to said receive channels with each sequence, the same radiating element, referred to as the reference element, being connected to said receive channels for all of the sequences, one cycle being completed when all the radiating elements have been connected at least once to one of said receive channels;

processing means performing, for each sequence, the estimation of the two-by-two spatial correlations of the signal received on the reference channel and the signals received on the other M-1 receive channels, then estimating the spatial power spectral density in N incoming directions on the basis of a coherent sum of the N correlation terms thus obtained.

The array of radiating elements being linear, the reference element is, for example, the first element, the M first elements being connected to the receive channels in the first sequence, then the M-1 radiating elements being connected to the receive channels in the second sequence, and so on.

In one possible embodiment, the processing means estimate the spatial correlations after having carried out the elimination of the short-duration stationary signals having a duration less than a given duration τ, the elimination of the short-duration stationary signals being effected by multiplying the signal received at a t, x(t), by a signal having the form x(t)x(t−τ)/x(t)*², where τ is a delay chosen to eliminate signals having a duration less than the duration τ.

In each sequence, said spatial correlation is, for example, estimated by multiplying directly the signal received on said reference radiating element by the conjugated signal received on a different radiating element of the antenna.

In a different possible embodiment, in each sequence, said spatial correlation is estimated by multiplying the signal received on said reference radiating element by the conjugated signal received on a different radiating element of the antenna, following frequency separation of said received signals.

In each sequence, said spatial correlation is, for example, estimated by multiplying the signal received on said reference radiating element by the conjugated signal received on a different radiating element of the antenna, the correlation estimation being carried out at the output of banks of filters having different widths and different center frequencies.

The filters are, for example, implemented by means of numerical Fourier transforms of different orders or by means of polyphase filters of different orders.

The device is, for example, a radar. In this case, in each sequence, said spatial correlation is, for example, estimated by multiplying the signal received on said reference radiating element by the conjugated signal received on a different radiating element of the antenna, following temporal separation of said received signals.

The temporal separation is, for example, obtained by means of adapted filtering and sampling of the pulses received by said radar.

Other characteristics and advantages of the invention will become evident from the description which follows, given with reference to the attached drawings, in which:

FIG. 1 is a synoptic diagram showing a linear antenna array comprising N radiating elements.

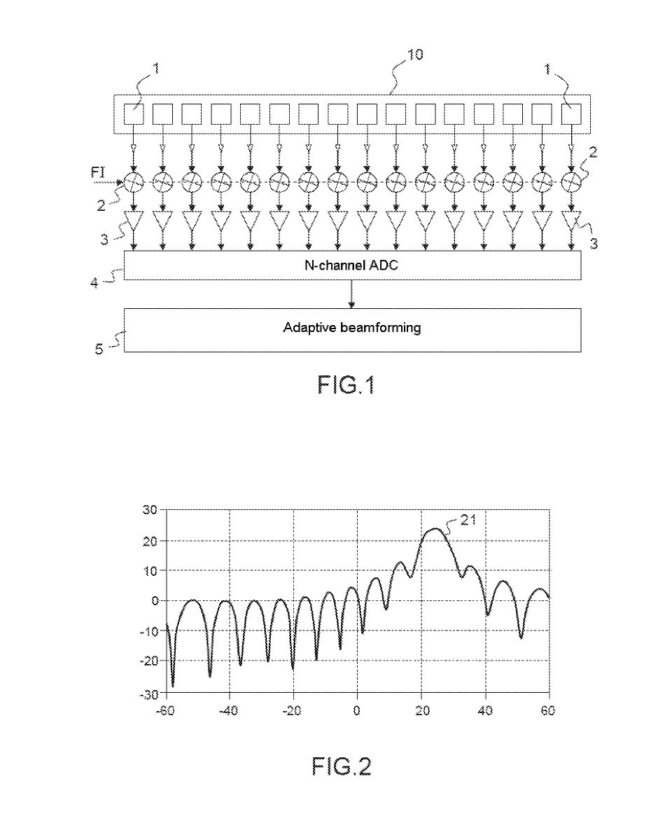

FIG. 2 shows an antenna pattern relating to a device of the type shown in FIG. 1;

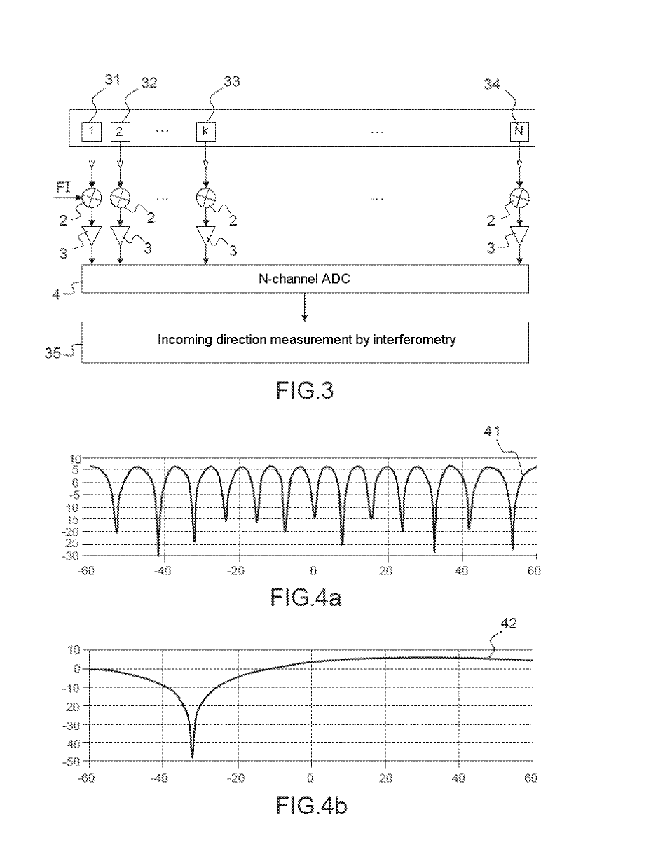

FIG. 3 shows an example of an interferometry device;

FIGS. 4a and 4b show an antenna pattern obtained by an ambiguous interferometer and by an unambiguous interferometer respectively;

FIG. 5 shows an illustration of the principle of the invention;

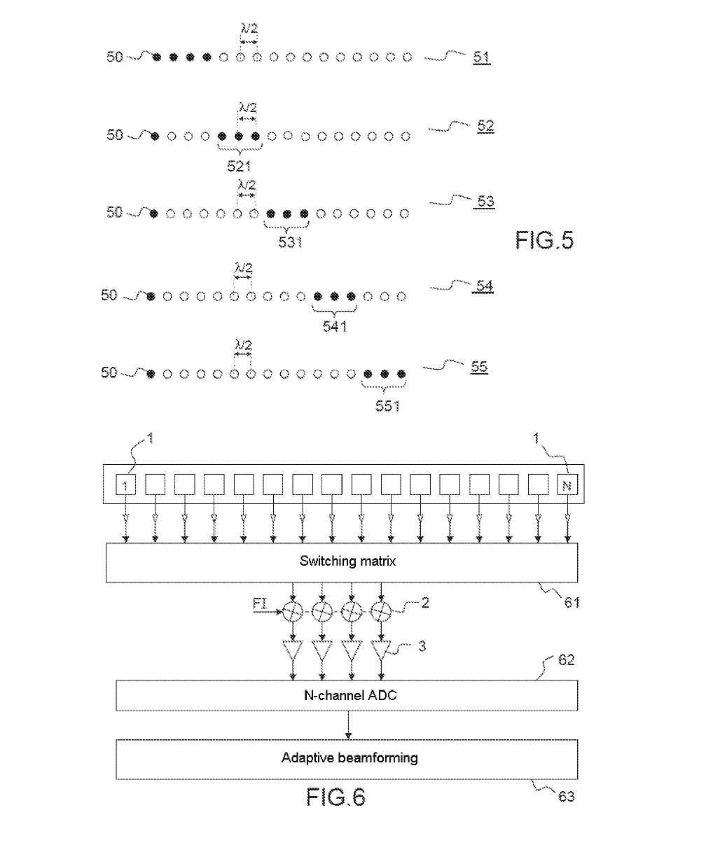

FIG. 6 is a synoptic diagram showing a first example embodiment of a device according to the invention;

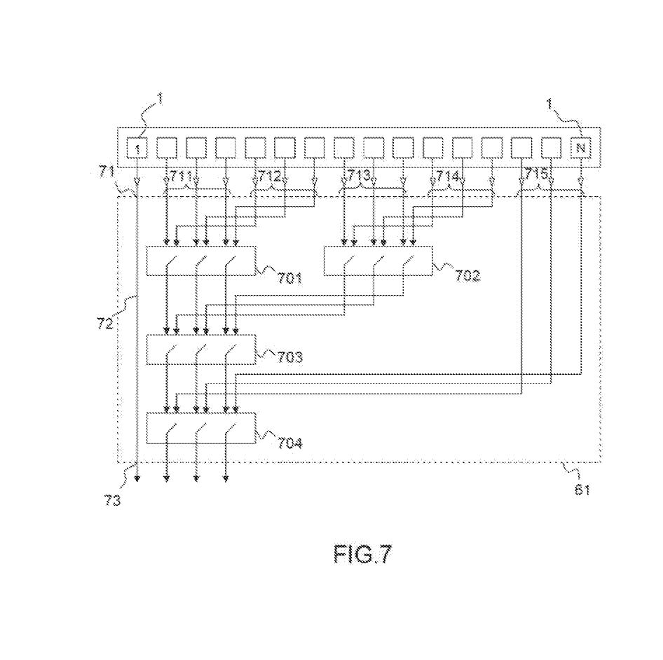

FIG. 7 shows an example embodiment of the switching means used in a device according to the invention;

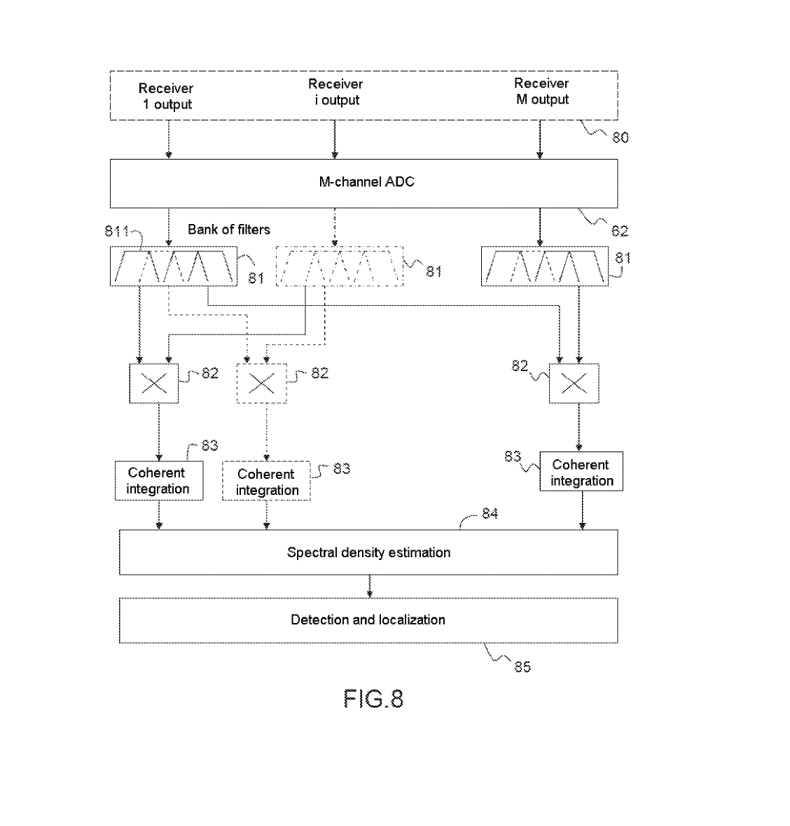

FIG. 8 shows a different example embodiment of a device according to the invention;

FIG. 1 is a synoptic diagram showing a linear antenna array comprising N radiating elements.

The invention applies to a surface antenna, having a dimension 2, or to a linear antenna, having a dimension 1, as shown in FIG. 1. By way of example, the invention will be described below for a linear antenna.

The network 10 comprises N radiating elements 1 spaced apart from one another by a half-wavelength. In an adaptive beamforming receiver, each radiating element 1 is connected to a receiver performing the amplification, filtering and frequency transposition of the received signal before coding. Thus, on reception, in order to perform the frequency transposition, each radiating element 1 is connected to an input of a hyperfrequency mixer 2, the other input of the mixer receiving an intermediate frequency. The output of a mixer 2 is connected to the input of a low-noise amplifier 3. The amplifiers 3 are connected at the output to the input of an N-channel coder 4. The latter performs the analog-to-digital conversion of the signals originating from the amplifiers. The received and coded signals are processed simultaneously by a processing unit 5 to form the beams.

The adaptive beamforming operation consists in summing in a coherent manner all of the signals xᵢ received for each pointing direction of the beam. It can be written according to the following relationship (1), S representing the amplitude of the signal, as a function of the look direction and the sampling period:

$$S ( {θ}_{k} , {nT}_{r} ) = {\sum }_{i = 0}^{N - 1} {x}_{i} ( {nT}_{r} ) {exp}^{- \frac{2 \cdot j \cdot π \cdot i \cdot d \cdot sin ( {θ}_{k} )}{λ}} \qquad ( 1 )$$

where:
θₖ is the look angle in the direction kθ (θₖ=kθ);
Tr is the sampling period of the received signals, on reception in the coders 4;
n is the index of the sampling time at which the beamforming is carried out;
i is the index of the radiating element;
d is the distance between two successive radiating elements;
λ is the wavelength of the signal.

Furthermore, the pointing directions are regularly spaced apart and their number is equal to the number N of radiating elements of the array. In these conditions, the beamforming simply corresponds to a Fourier transform and can be written according to the relationship (2) below:

$$S ( {θ}_{k} , {nT}_{r} ) = {\sum }_{i = 0}^{N - 1} {x}_{i} ( {nT}_{r} ) {exp}^{- \frac{2 \cdot j \cdot π \cdot i \cdot k}{N}} \qquad ( 2 )$$

where the frequency fₖ and the time t are expressed as follows:

$${f}_{k} = \frac{sin {θ}_{k}}{λ}$$

$$t = i \cdot d$$

The index k corresponds to the index of the incoming direction θₖ in which a beam is to be formed. When sin θ=λk/Nd, a maximum is obtained in the direction θₖ.

The device shown in FIG. 1 thus enables N directional beams to be formed, having a typical aperture equal to 2/N radians, without ambiguity and with secondary-lobe levels adjustable by numerical weighting. This device therefore enables highly effective angular separation and localization of the emission sources.

FIG. 2 shows, by way of a curve 21, an example of an antenna pattern obtained without weighting for a device of the type shown in FIG. 1, for a particular pointing, the y-axis showing the gain in dB and the x-axis the angular position.

Unfortunately, a device of this type may prove to be highly complex, particularly when the number of channels is large due to a high sampling frequency and/or one or more of the following requirements:
fine angular resolution;
substantial angular coverage;
high RF frequency.

For example, in a passive device for radar signal interception, these conditions are combined, thus making the implementation of a solution of this type highly complicated. This is notably a reason for which interferometric baselines are generally used, as shown in FIG. 3, in order to enable angular localization of the different emission sources over a huge angular range.

FIG. 3 therefore shows a device formed from interferometric baselines, used for the angular localization of the different emission sources over a substantial angular range.

In a device of this type, at least one very precise but ambiguous measurement is carried out by means of a large baseline comprising the most distant antenna elements, and at least one unambiguous but imprecise measurement is carried out by means of a baseline comprising the two nearest antenna elements. The device shown in FIG. 3 comprises four radiating elements 31, 32, 33, 34, knowing that at least three elements could suffice to carry out a measurement of the incoming direction of signals by interferometry. Assuming the elementary distance d, forming one step, and by furthermore assuming the position of the first element 31 as the original position, the second element is then at the position d, the third element at a position kd and the fourth element is placed at a position Nd. The radiating elements are each connected to a mixer 2, receiving on a different input a frequency FI originating from a local oscillator, followed by a low-noise amplifier 3 in a manner similar to the device shown in FIG. 1. The signals originating from the amplifiers 3 are then digitally converted by a multi-channel analog-to-digital converter 4 of the same type, for example, as shown in FIG. 1. The thus digitized signals are taken into account by processing means 35 for the incoming direction measurement by interferometry.

The combination of the phase measurements obtained on the different baselines, comprising the radiating elements 31, 32, 33, 34, allows the ambiguity to be eliminated.

Typically, assuming the synoptic diagram shown in FIG. 3, it is possible, for a given wavelength λ, to estimate the following phase differences between the first element and the elements at positions d, kd and Nd respectively:

$${Φ}_{1} - {Φ}_{2} = \frac{2 π d sin ( θ )}{λ}$$

$${Φ}_{1} - {Φ}_{k} = \frac{2 π d k sin ( θ )}{λ}$$

$${Φ}_{1} - {Φ}_{N} = \frac{2 π dN sin ( θ )}{λ}$$

then, following elimination of ambiguity according to the methods known to the person skilled in the art, to deduce the incoming direction of the signal θ therefrom.

The device shown in FIG. 3, which includes only a small number of receive channels, is much simpler than the device shown in FIG. 1. However, if it enables localization of the different incoming directions of signals originating from emission sources with a high precision, it does not generally enable separation of these different emission sources on its own, and may fail if the signal-to-noise ratio is not sufficient.

FIGS. 4a and 4b show an antenna pattern obtained by an ambiguous interferometer and by an unambiguous interferometer respectively. More particularly, the curve 41 in FIG. 4a shows the antenna pattern for an interferometer made up of the two most distant bases 31, 34, being distanced by Nd, in an axis system where the y-axis shows the antenna gain and the x-axis the angle θ. The curve 42 in FIG. 4b shows the antenna pattern for an interferometer made up of the two closest bases 31, 32, distanced by d, in the same axis system.

The principle of the invention is shown in FIG. 5. According to the invention, on the basis of a device of the type shown in FIG. 1, having N radiating elements, the number of receivers is reduced from N to M, M being less than N, by switching the M receivers in a certain way onto the different radiating elements 1 over time. In the description below, an example will be given wherein M=4 and N=16. The M receivers form what will be referred to below as the receive device.

Provided that each radiating element is connected to the receive device at least once during the observation time, it is then possible to separate the stationary incoming signals during the observation time according to N directional beams in accordance with the result obtained by a conventional adaptive beamforming.

FIG. 5 shows an example of switching sequences 51, 52, 53, 54, 55 included in the observation time, allowing each radiating element to be connected at least once to the receive device. The different sequences shown represent the position of the N receivers, 16 in the example shown in FIG. 5, the receivers indicated by a black dot being those which are connected to the receive device. The elements are, for example, spaced apart from one another by a distance λ/2.

For all sequences, the first radiating element 50 is connected to the receive device. This first element 50 thus constitutes the reference element. It is not necessary to take the first element 50 as the reference element, since other elements of the array could constitute a reference element, provided that this element is connected to the connection device with each sequence.

In the first sequence 51, the M first elements are connected to the switching device. In the second sequence 52, the first element 50 is connected and the M-1 elements following 521 are connected. In the third sequence 53, the first element 50 is connected and the M-1 elements following 531 are connected. In the fourth sequence 54, the first element 50 is connected and the M-1 elements following 541 are connected. Finally, in the last sequence 52, the first element 50 is connected and the M-1 elements following 551 are connected. These last M-1 elements 551 are the M-1 elements of the N-element array, N being equal to 16 and M being equal to 4.

The method of connecting the elements to the receive device shown in FIG. 5 has the advantage of being particularly simple to implement. Other connection methods are obviously possible, provided that they allow each element at least to be connected during the set of sequences 51, 52, 53, 54, 55.

With each sequence, the mathematical expectation of the product of the signal received on the reference antenna element is calculated by the complex conjugate of each of the received signals of the M-1 other antenna elements connected to the receive device, i.e. for i between 1 and M:

Rₓ(i, nTᵣ)=E└x₁(nTᵣ)x*ᵢ₊₁(nTᵣ)┘ (3)

where:
x₁(nTr) is the signal received on the channel 1 on the date nTr, Tr being the previously defined sampling period;
x₁₊ᵢ(nTr) is the signal received on the channel i+1 on the date nTr, x*₁₊ᵢ(nTr) being its conjugate;

E[x] represents the mathematical expectation over nTr time samples on the basis of a position pTr:

$$E [ x ( p \cdot {nT}_{r} ) ] = \frac{1}{n} {\sum }_{l = 0}^{n - 1} x ( {pT}_{r} + l \cdot {T}_{r} ) \qquad ( 4 )$$

Rₓ(i,nTr) shows the correlation between the signal received on the channel 1 and the complex conjugate of the signal received on the channel i+1 on the date nTr.

Assuming that the signal is stationary and narrowband in relation to the carrier, and that the amplitude of the received signal and its incoming direction are constant during the observation time, the correlation between the received signals of any two radiating elements can be considered to be invariant over time, to within the measurement noise. Thus, regardless of the times nTr and pTr:

Rₓ(i,nTᵣ)=Rₓ(i,p.nTᵣ)=Rₓ(i) (5)

And for a received signal having an amplitude A, a wavelength λ and an incoming direction θ, the correlation Rₓ(i) is expressed as follows:

$${R}_{x} ( i ) = {A}^{2} {exp}^{- \frac{2 \cdot j \cdot π \cdot i \cdot d \cdot sin ( θ )}{λ}} \qquad ( 6 )$$

The spatial power spectral density S(θₖ) in a spatial filter having a direction θₖ can then be estimated according to the following relationship:

$$S ( {θ}_{k} ) = {\sum }_{i = 0}^{N - 1} {R}_{x} ( i ) {exp}^{- \frac{2 \cdot j \cdot π \cdot i \cdot k}{N}} \qquad ( 7 )$$

k having been defined relatively to the relationship (2).

It should be noted that, even if the amplitude of the signal A is not strictly constant over time, beamforming remains possible, but with a degradation in the spatial resolution.

FIG. 6 shows, by way of a synoptic diagram, an example embodiment of a device according to the invention in the case where the receive device comprises four receivers, i.e. M=4, to which device the sequences shown in FIG. 5 can be applied. The device comprises an array 10 of N radiating elements 1, N being equal to 16. The radiating elements are connected to the receive device via a switching matrix 61 enabling the different switching sequences to be implemented, for example the previously described sequences 51, 52, 53, 54, 55. The output of the switching matrix is connected to the four receivers, each receiver comprising at least one mixer 2, transposing the received signal to an intermediate frequency FI, and an amplifier 3. The signals at the output of a receiver are digitized by an M-channel analog-to-digital converter 62. The digitized received signals are processed by processing means 63 performing the calculations defined in the previously defined relationships (3) to (7). The processing means can be implemented by means of an FPGA circuit or by a signal processing processor.

If the sequences shown in FIG. 5 are applied, the processing means calculate the correlations Rₓ(i) as indicated below for each sequence, where they perform a two-by-two correlation of the receive channels with the reference channel.

1st Sequence 51:
Reception of the radiating elements at positions 1, 2, 3 and 4.
Calculation of Rₓ(i) over the time frame [0, nTr]:

Rₓ(0)=E(x₁(nTᵣ)x*₁(nTᵣ))

Rₓ(1)=E(x₁(nTᵣ)x*₂(nTᵣ))

Rₓ(2)=E(x₁(nTᵣ)x*₃(nTᵣ))

Rₓ(3)=E(x₁(nTᵣ)x*₄(nTᵣ))

2nd Sequence 52:
Reception of the radiating elements at positions 1, 5, 6 and 7.
Calculation of Rₓ(i) over the time frame [nTr, 2nTr]:

Rₓ(4)=E(x₁(2nTᵣ)x₅*(2nTᵣ))

Rₓ(5)=E(x₁(2nTᵣ)x₆*(2nTᵣ))

Rₓ(6)=E(x₁(2nTᵣ)x₇*(2nTᵣ))

3rd Sequence 53:
Reception of the radiating elements at positions 1, 8, 9 and 10.
Calculation of Rₓ(i) over the time frame [3nTr, 4nTr]:

Rₓ(7)=E(x₁(3nTᵣ)x₈*(3nTᵣ))

Rₓ(8)=E(x₁(3nTᵣ)x₉*(3nTᵣ))

Rₓ(9)=E(x₁(3nTᵣ)x₁₀*(3nTᵣ))

4th Sequence 54:
Reception of the radiating elements at positions 1, 11, 12 and 13.
Calculation of Rₓ(i) over the time frame [4nTr, 5nTr]:

Rₓ(10)=E(x₁(4nTᵣ)x₁₁*(4nTᵣ))

Rₓ(11)=E(x₁(4nTᵣ)x₁₂*(4nTᵣ))

Rₓ(12)=E(x₁(4nTᵣ)x₁₃*(4nTᵣ))

5th Sequence 55:
Reception of the radiating elements at positions 1, 14, 15 and 16.
Calculation of Rₓ(i) over the time frame [5nTr, 6nTr]:

Rₓ(13)=E(x₁(5nTᵣ)x₁₄*(5nTᵣ))

Rₓ(14)=E(x₁(5nTᵣ)x₁₅*(5nTᵣ))

Rₓ(15)=E(x₁(5nTᵣ)x₁₆*(5nTᵣ))

Finally, the estimation of the special power spectral density in different directions θₖ allows the incoming direction of the received wave to be determined, as expressed in the following relationship:

$$S ( {θ}_{k} ) = {\sum }_{i = 0}^{15} {R}_{x} ( i ) {exp}^{- \frac{2 \cdot j \cdot π \cdot i \cdot k}{16}} \qquad ( 8 )$$

The calculation can also be performed sequentially, by estimating the partial sums with each sequence and cumulating them from sequence to sequence before arriving at the sum total.

FIG. 7 shows an example embodiment of the switching matrix 61. The switching matrix comprises N inputs and M outputs, more particularly 16 inputs and 4 outputs in the example shown in FIG. 7. It is implemented by means of SPXT PIN diode switching blocks 701, 702, 703, 704. Each block comprises three elementary switches.

The first input 71 is connected via a direct line 72 to a first output 73, enabling the reference radiating element to be continuously connected to the receive device. The following three inputs 711 are each connected to a switch of a first block 701. The following three inputs 712 are connected to these same switches and the 2nd input is switched onto the 5th input and so on. The following three inputs 713 are each connected to a switch of a second block 702. The following three inputs 714 are connected to these same switches and the 8th input is switched onto the 12th input and so on. The outputs of the first block 701 are each connected to a switch of a third block 703. The outputs of the second block 702 are connected to these same switches, and the first output of the first block 701 is switched onto the first output of the second block 702 and so on.

The outputs of the third block 703 are each connected to a switch of a fourth block 704. The last three inputs 715 of the matrix are connected to these same switches, and the 14th input is switched onto the first output of the third block 703 and so on. The outputs of the 4th block 704 are each connected to a receiver 2, 3 of the receive device.

The architecture of the switching matrix shown in FIG. 7 notably enables the switching sequences shown in FIG. 5 to be implemented. The first sequence is thus implemented by switching the first block 701 onto the 2nd, 3rd and 4th inputs, then by switching the third block 703 onto the outputs of the first block 701, and finally by switching the fourth block 704 onto the outputs of the third block 703.

The invention is applied notably to the detection and localization of radar signals. In this context, it can be applied to an active radar interceptor or a passive interceptor, for example an RESM (Radar Electronic Support Measure) interceptor, suitable for detecting signals with a low signal-to-noise ratio and pulses having a long duration, typically greater than 100 μs.

In the case of an active radar interceptor, the time characteristics and frequency characteristics of received signals are known. In radar, this is conventionally the case where the received signals are subjected to a filtering adapted to the emitted waveform, this filtering enabling both optimization of the signal-to-noise ratio and separation of these signals into different distance and/or Doppler compartments. In this case, the spatial correlation is estimated following temporal separation of the received signals.

At the end of each processing period Tr, a distance-Doppler matrix is provided in which all of the received signals are distributed. If, as previously, an antenna having N radiating elements is assumed, each radiating element connected to the receiver has a corresponding distance-Doppler matrix in each processing period. The previously described beamforming processing is applied in parallel to each of the outputs of the distance-Doppler compartments.

In the case of an RESM passive radar interceptor, the time characteristics and frequency characteristics of the received signals are unknown. A first rough separation of the signals is, for example, performed by analog frequency filtering, the receivers having a limited bandwidth.

Following digitization of the signal, a second separation can be performed to limit the presence of short-duration signals, corresponding to non-stationary signals, at the processing input. This can be implemented by multiplying the received signal x(t) at the time t by a weighting Pond, defined by the following relationship:

Pond=x(t)x(t−τ)/x(t)*² (9)

where τ is a delay chosen in order to eliminate the signals having a duration less than the duration τ.

A third, finer separation, aiming to separate the signals and optimize their signal-to-noise ratio, is performed by means of digital filtering, according to their center frequency and their bandwidth.

This operation is carried out, for example, using FFT filters or polyphase filters having a plurality of different widths ΔF₁.

For example, for a receiver having a bandwidth ΔF=100 MHz, a bank of 25 MHz filters, another bank of 12.5 MHz filters and a third bank of 1.56 MHz filters can be provided for the third separation, wherein these filters may or may not be cascaded.

Thus, if the signal sampling period is equal to Te=1/2 ΔF, the following group of filters can be formed:
4 filters having a bandwidth ΔF/4=25 MHz with a repetition period of 4Te=40 ns;
8 filters having a bandwidth ΔF/8=12.5 MHz with a repetition period of 8Te=80 ns;
64 filters having a bandwidth ΔF/64=1.56 MHz with a repetition period of 64Te=640 ns.

FIG. 8 shows a functional example embodiment in the case of an application to a passive interceptor. The device is shown at outputs 80 of the M receivers. The output signals of the M receivers originate from the N radiating elements, via the switching matrix 61. They are digitized by the M-channel analogue-to-digital converter 62. Each output channel of this converter is connected to a bank of filters 81. Each i-order radiating element connected to the receive device at a time T has a corresponding group of filters 811 having a center frequency Fₘ and a bandwidth ΔF₁. A bank of filters 81 comprises, for example, the group of filters described above.

The terms of correlation between the received signals of the i-order and j-order radiating elements, i.e. between the channels i and j, are obtained by calculating the mean value of the product 83 of the output of each filter S_{m,l,i,k} connected to the channel i at the time kT with the conjugate of the output of the filter having the same center frequency and the same bandwidth filters connected to the channel j at the time kT. This is expressed by the following relationship:

$${R}_{i , j , m , l} ( pT ) = E ( {S}_{m , l , i , k} {S}_{m , l , j , k}^{*} ) = {\sum }_{k = p}^{p + R} ( {S}_{m , l , i , k} {S}_{m , l , j , k}^{*} ) \qquad ( 10 )$$

where:
S_{m,l,i,k} represents the output of the filter having the center frequency Fₘ, the bandwidth ΔF₁, connected to the channel i at the time kT;
S*_{m,l,j,k} represents the conjugate of the output of the filter having the center frequency Fₘ, the bandwidth ΔF₁, connected to the channel j at the time kT;
RT represents the time interval over which the mean is calculated;
pT represents the time at which the mean is calculated;
R_{i,j,m,l} (pT) represents the correlation between the received signals of the channels having the index i and the index j for the filters having the center frequency Fₘ and the bandwidth ΔF₁, at the time pT.

The signals being assumed to be narrowband and constant in amplitude and incoming direction during the observation time, the correlation terms are independent from the time, i.e.:

R_{i,j,m,l}(pT)=R_{i,j,m,l} (11)

The set of correlation terms is thus estimated 82 according to a set of successive sequences during which the M-channel receive device is connected successively to the different radiating elements that make up the antenna.

The set of results is then summed in a coherent manner 83 for each spatial direction and for each filter.

If it is assumed that R_{i,m,l}=R_{i,j+i,m,l,} the correlation of the signals originating from the radiating elements j and j+i for the filters having the center frequency Fₘ and the bandwidth ΔF₁, the estimation of the spatial power spectral density 84 at the output of the filters having the center frequency fFₘ and the bandwidth ΔFₗ is written for the direction θₖ:

$$S ( {θ}_{k} ) = {\sum }_{i = 0}^{N} {R}_{i , m , l} ( i ) {exp}^{- \frac{2 πji k}{N}} \qquad ( 12 )$$

The result of this estimation is then used for the detection and subsequent angular localization of the received signals 85, according to conventional radar processing principles. The processing means notably implement the filter banks 81, the correlations 82, the coherent integrations 83 and the estimation of the spectral density in the different directions linked to the antenna elements.

In the example of a 16-channel antenna according to the pattern shown in FIG. 6 which uses a receiver having 4 simultaneous channels, 5 sequences are typically necessary in order to calculate all the correlation terms enabling the beamforming, as shown by the estimations of these terms Rₓ(i) in the previously described sequences 51, 52, 53, 54, 55.

Furthermore, if signals having a duration greater than 100 μs are to be analyzed, 20 μs can be allocated per sequence, i.e., each correlation term can be estimated during a total time RT=20 μs.

If, for example, the angular separation is performed in each filter having a bandwidth ΔF/4=25 MHz, the signal at the output of each filter thus provides one sample every 40 ns and the mean of the produced terms can be calculated over 500 successive samples.

In addition to the angular separation, this method enables a coherent temporal integration of the received signal during a time close to the total duration of this signal, which is very useful for detecting low peak power (LPI) signals, notably having any given modulation. The integration of the different correlation terms can advantageously be adapted to detect signals having a long duration, for example greater than 100 μs, low peak power, for example less than several watts, and any given unknown modulation.

1. A device for detecting electromagnetic signals comprising an array receive antenna having N radiating elements, said device comprising M receive channels downstream of the receive antenna, M being less than N, the pointing directions of said antenna, equal in number to the number N of radiating elements, being obtained by means of adaptive beamforming and being regularly spaced apart, said device comprises at least:
means for switching the M receive channels onto the radiating elements according to successive sequence cycles, M radiating elements being connected to said receive channels with each sequence, the same radiating element, referred to as the reference element, being connected to said receive channels for all of the sequences, one cycle being completed when all the radiating elements have been connected at least once to one of said receive channels;
processing means performing, for each sequence, the estimation of the two-by-two spatial correlations of the signal received on the reference channel and the signals received on the other M-1 receive channels, then estimating the spatial power spectral density in N incoming directions on the basis of a coherent sum of the N correlation terms thus obtained.

2. The device as claimed in claim 1, wherein the array of radiating elements being linear, the reference element is the first element, the M first elements being connected to the receive channels in the first sequence, then the M-1 radiating elements being connected to the receive channels in the second sequence, and so on.

3. The device as claimed in claim 2, wherein the processing means estimate the spatial correlations after having carried out the elimination of the short-duration stationary signals having a duration less than a given duration τ, the elimination of the short-duration stationary signals being effected by multiplying the signal received at a time t, x(t), by a signal having the form x(t)x(t−τ)/x(t)*², where τ is a delay chosen to eliminate the signals having a duration less than the duration τ.

4. The device as claimed in claim 1, wherein in each sequence, said spatial correlation is estimated by multiplying directly the signal received on said reference radiating element by the conjugated signal received on a different radiating element of the antenna.

5. The device as claimed in claim 1, wherein in each sequence, said spatial correlation is estimated by multiplying the signal received on said reference radiating element by the conjugated signal received on a different radiating element of the antenna, after frequency separation of said received signals.

6. The device as claimed in claim 5, wherein in each sequence, said spatial correlation is estimated by multiplying the signal received on said reference radiating element by the conjugated signal received on a different radiating element of the antenna, the correlation estimation being carried out at the output of banks of filters having different widths and different center frequencies.

7. The device as claimed in claim 6, wherein the filters are implemented by means of numerical Fourier transforms of different orders.

8. The device as claimed in claim 6, wherein the filters are implemented by means of polyphase filters of different orders.

9. The device as claimed in claim 1, wherein said device is a radar.

10. The device as claimed in claim 9, wherein in each sequence, said spatial correlation is estimated by multiplying the signal received on said reference radiating element by the conjugated signal received on a different radiating element of the antenna, following temporal separation of said received signals.

11. The device as claimed in claim 10, wherein the temporal separation is obtained by means of adapted filtering and sampling of the pulses received by said radar.
